(19) United States
(12) Patent Application Publication
(10) Pub. No.: US 2015/0188346 A1
(43) Pub. Date: Jul. 2, 2015

(54) ELECTRONIC DEVICE, CHARGE, AND ELECTRONIC DEVICE SYSTEM

(71) Applicant: Panasonic Intellectual Property Corporation of America, Torrance, CA (US)

(72) Inventor: Hiroyuki Oku, Kanagawa (JP)

(73) Assignee: Panasonic Intellectual Property Corporation of America, Torrance, CA (US)

(21) Appl. No.: 14/416,521

(22) PCT Filed: Dec. 20, 2013
(86) PCT No.: PCT/JP2013/007500

§ 371 Date: Jan. 22, 2015

(30) Foreign Application Priority Data
Dec. 21, 2012 (JP) 2012-279515
Jan. 21, 2013 (JP) 2013-008540
Feb. 8, 2013 (JP) 2013-023454

(51) Int. Cl. H02J 7/00

(52) U.S. Cl. CPC H02J 7/0055; H02J 7/007; H02J 7/0029; H02J 2007/0039

(57) ABSTRACT

An electronic device 1 includes a secondary battery 20, a charging connection section P1 configured to be connected to an external charger 30, a switch section 16 electrically connected to the charging connection section P1 and the secondary battery 20 and configured to perform switching between conduction and shut-off, and an authentication communication connection section T1 configured to receive at least first data. The switch section 16 can become conductive in the case that the first data is predetermined data and that the voltage of the charging connection section P1 is a predetermined voltage, and the switch section is shut off at least in the case that the first data is not the predetermined data or in the case that the voltage of the charging connection section P1 is not the predetermined voltage.

### TECHNICAL FIELD

The present invention relates to an electronic device, a charger, and an electronic device system capable of safely charging secondary batteries.

### BACKGROUND ART

Recently, in electronic devices serving as mobile terminals, such as smart phones and tablets, the secondary battery thereof is required to have an increased battery capacity (larger capacity), a quick charging capability, a longer life, etc. Furthermore, as the capacity becomes larger, quick charging is required; as a result, a large current flows in the electronic devices during charging.

Conventionally, a charge control circuit for controlling the (DC) voltage supplied from a charger (AC adapter) for converting household AC power into DC power to the voltage for a secondary battery has been provided on the side of an electronic device (for example, the voltage is lowered from 5 V to 4 V). However, heat is generated due to conversion loss in this charge control circuit, thereby causing a problem of increasing heat generation in the electronic device. For this reason, it has been proposed that the charge control circuit generating most of the heat is mounted on the side of a stationary charger (AC adapter) (for example, refer to Patent Document 1).

### PRIOR ART DOCUMENT

### Patent Document

Patent Document 1: JP-A-2012-175895

### GENERAL DESCRIPTION OF THE INVENTION

### Problem that the Invention is to Solve

On the side of the electronic device described in Patent Document 1, a circuit for controlling voltage and current does not substantially exist between the secondary battery and the terminals of the electronic device connected to the charger since the charge control circuit has been moved to the side of the charger. Hence, even if the terminals themselves of the secondary battery are not exposed physically, terminals having potentials almost the same as that of the secondary battery are exposed outside. In this state, breakage or the like of the electronic device may occur because of short-circuit due to contact with a foreign substance from the outside or because of the connection of an unauthorized charger. Hence, it is difficult to say that the user is in a situation in which he can use the electronic device without anxiety.

The present invention has been made in consideration of the above-mentioned circumstances, and an object of the present invention is to provide an electronic device, a charger, and an electronic device system in which the safety of charging is ensured by charging the secondary battery using the authorized charging device.

### Means for Solving the Problem

The electronic device according to the present invention is an electronic device equipped with a secondary battery; a charging connection section configured to be connected to an external charger; a switch section electrically connected to the charging connection section and the secondary battery and configured to perform switching between conduction and shut-off; and an authentication communication connection section configured to receive at least first data, and the electronic device is capable of operating by using the secondary battery as a power source, wherein the switch section can become conductive in the case that the first data is predetermined data and that the voltage and the current of the charging connection section are a predetermined voltage, and the switch section is shut off at least in the case that the first data is not the predetermined data or in the case that the voltage of the charging connection section is not the predetermined voltage and current.

As an aspect of the electronic device according to the present invention, for example, the charging connection section and the authentication communication connection section of the electronic device are used in common.

The charger according to the present invention is equipped with a charging connection section configured to be connected to an external electronic device and an authentication communication connection section configured to receive at least second data, and the charger is capable of charging the electronic device, wherein the charger applies predetermined voltage and current to the charging connection section in the case that the second data is predetermined data, and the charger does not apply the predetermined voltage and current to the charging connection section at least in the case that the second data is not the predetermined data.

As an aspect of the charger according to the present invention, for example, the charging connection section and the authentication communication connection section of the charger are used in common.

As another aspect of the charger according to the present invention, for example, the charger can pass a current equal to or more than a predetermined current to the charging connection section.

The electronic device system according to the present invention is equipped with the electronic device and the charger, and the charging connection section of the electronic device can be connected to the charging connection section of the charger, and the authentication communication connection section of the electronic device can be connected to the authentication communication connection section of the charger.

The electronic device system according to the present invention includes an electronic device that is equipped with a secondary battery and a voltage detection section capable of detecting the voltage of the secondary battery and that can operate by using the secondary battery as a power source and a charger configured to be connected to the electronic device and configured to perform at least constant voltage supply and constant current control for the electronic device, wherein the charger can perform constant current control at least in the case that the voltage is equal to or less than a predetermined voltage value.

As an aspect of the electronic device system according to the present invention, for example, the charger can perform constant current control in the case that the voltage is equal to or less than a predetermined voltage value, and the charger performs constant voltage supply in the case that the voltage is larger than the predetermined voltage value.

As another aspect of the electronic device system according to the present invention, for example, the electronic device performs constant voltage control for the secondary battery in the case that the voltage is larger than the predetermined voltage value.

As still another aspect of the electronic device system according to the present invention, for example, the charger performs constant voltage supply in the case that the predetermined voltage value is a first voltage value and that the voltage is smaller than a second voltage value smaller than the first voltage value.

As still another aspect of the electronic device system according to the present invention, for example, the electronic device performs constant current control for the secondary battery in the case that the voltage is smaller than the second voltage value.

As still another aspect of the electronic device system according to the present invention, for example, the electronic device can notify the charger of the voltage.

As still another aspect of the electronic device system according to the present invention, for example, the electronic device can notify the charger of the voltage as a digital signal.

As still another aspect of the electronic device system according to the present invention, for example, electrical connection can be made between the electronic device and the charger via a cord having a plurality of conductive wires.

As still another aspect of the electronic device system according to the present invention, for example, the current at the output of the charger at the time of the constant current control is larger than the current at the time of the constant voltage supply.

As still another aspect of the electronic device system according to the present invention, for example, the current at the output of the charger at the time of the constant current control is larger than at least the maximum current at the time of the constant voltage supply.

As still another aspect of the electronic device system according to the present invention, for example, the charger can operate on the basis of a commercial AC power source.

The electronic device according to the present invention is equipped with a secondary battery and a charging connection section configured to be connected to an external charger, and the electronic device can charge the secondary battery on the basis of the electric power supplied to the charging connection section and can operate by using the secondary battery as a power source, wherein the electronic device can notify the charger of the internal impedance of the secondary battery.

As another aspect of the electronic device according to the present invention, for example, the electronic device is equipped with an authentication communication connection section configured to be connected to the charger, wherein the internal impedance can be notified to the charger via the authentication communication connection section.

As still another aspect of the electronic device according to the present invention, for example, the charging connection section and the authentication communication connection section of the electronic device are used in common.

As still another aspect of the electronic device according to the present invention, for example, the secondary battery has a protection circuit, and part of the internal impedance is caused by the impedance of the protection circuit.

As still another aspect of the electronic device according to the present invention, for example, the internal impedance can be acquired.

The charger according to the present invention is a charger equipped with a charging connection section configured to be connected to an external electronic device, and the charger can perform constant current control for the electronic device, can receive the internal impedance of the secondary battery provided in the electronic device, and can perform constant current control for the electric power supplied to the electronic device via the charging connection section so that a predetermined current value based on the internal impedance is obtained.

As still another aspect of the charger according to the present invention, for example, the charger is equipped with an authentication communication connection section configured to be connected to the electronic device, and the charger can receive the internal impedance via the authentication communication connection section.

As still another aspect of the charger according to the present invention, for example, the charging connection section and the authentication communication connection section of the charger are used in common.

As still another aspect of the charger according to the present invention, for example, the predetermined current value becomes a first current value and then becomes a second current value smaller than the first current value.

The charger according to the present invention acquires the voltage of the secondary battery and acquires a first offset voltage, that is, the product of the first current value and a predetermined impedance equal to or less than the internal impedance, and in the case that the acquired voltage of the secondary battery has reached a first threshold voltage, that is, the sum of a predetermined voltage value determined beforehand and the first offset voltage, the charger supplies the second current value instead of the first current value to the electronic device.

As still another aspect of the charger according to the present invention, for example, the charger acquires the voltage V of the secondary battery and acquires an offset voltage Vₙ, that is, the product of a current value Iₙ and a predetermined impedance equal to or less than the internal impedance, and in the case that the acquired voltage E of the secondary battery has reached an nth threshold voltage, that is, the sum of the predetermined voltage value and the offset voltage Vₙ, the charger supplies a current value Iₙ₊₁ instead of the current value Iₙ to the electronic device; n is a positive integer of 1 or larger (n=1, 2, 3, . . . ), and a relationship of 1ₙ>Iₙ₊₁ is established.

As still another aspect of the charger according to the present invention, for example, the charger performs the constant current charging until the current value Iₙ reaches the current obtained at the time when constant voltage charging is started after the constant current control.

The electronic device system according to the present invention includes the electronic device and the charger.

Another electronic device according to the present invention is equipped with first and second charging connection sections configured to be connected to an external charger; a switch section configured to perform switching between conduction and shut-off of an electric path for electrically connecting the first charging connection section and a detachable secondary battery at the time when the detachable secondary battery is mounted; a communication connection section configured to at least receive first authentication data from and transmit second authentication data to the external charger; and a charging power output section configured to output the charging power supplied from the second charging connection section to the secondary battery, and the electronic device can operate by using the secondary battery as a power source, wherein the switch section can become conductive in the case that the first authentication data received by the electronic device is predetermined data and that the charging voltage applied to the first charging connection section after the electronic device transmitted the second authentication data is within a predetermined range, and the switch section cannot become conductive at least in the case that the received first authentication data is not the predetermined data, and the secondary battery can be charged by using the charging power supplied to either the first or second charging connection section.

Still another electronic device according to the present invention is equipped with first and second charging connection sections configured to be connected to an external charger; a switch section electrically connected to the first charging connection section and a detachable secondary battery at the time when the detachable secondary battery is mounted and being configured to perform switching between conduction and shut-off; a communication connection section configured to at least receive first authentication data from and transmit second authentication data to the external charger; and a charging power output section configured to output the charging power supplied from the second charging connection section to the secondary battery at a predetermined level, and the electronic device can operate by using the secondary battery as a power source, wherein the switch section can become conductive in the case that the first authentication data received by the electronic device is predetermined data and that the charging voltage applied to the first charging connection section after the electronic device transmitted the second authentication data is almost the same as a predetermined value, and the switch section cannot become conductive at least in the case that the received first authentication data is not the predetermined data or the applied charging voltage is not almost the same as the predetermined value, and the secondary battery can be charged by using the charging power supplied to either the first or second charging connection section.

As still another aspect of the electronic device according to the present invention, for example, the electronic device is equipped with a second communication connection section capable of transmitting at least command data to the external charger, and charging power is supplied to either the first or second charging connection section on the basis of the transmitted command data.

Still another electronic device system according to the present invention includes an electronic device equipped with a secondary battery; a first charging connection sections configured to be connected to an external charger; a switch section electrically connected to the first charging connection section and a detachable secondary battery at the time when the detachable secondary battery is mounted and being configured to perform switching between conduction and shut-off; a first communication connection section configured to at least receive first authentication data from and transmit second authentication data to the external charger; and a second communication connection section capable of transmitting at least command data, and the electronic device being operable by using the secondary battery as a power source, and the system further includes a charger equipped with a second charging connection section configured to be connected to the electronic device; a third communication connection section capable of at least transmitting the first authentication data to and receiving the second authentication data from the electronic device; a fourth communication connection section configured to at least receive the command data from the electronic device; and a first charging power output section configured to output charging power to the second charging connection section, wherein the switch section can become conductive in the case that the first authentication data received by the electronic device is predetermined data and that the charging voltage applied to the first charging connection section after the electronic device transmitted the second authentication data is almost the same as a predetermined value, and the switch section cannot become conductive at least in the case that the received first authentication data is not the predetermined data or the applied charging voltage is not almost the same as the predetermined value, and the charger performs control for judging whether the first charging power output section outputs a predetermined current to the second charging connection section on the received command data.

As still another aspect of the electronic device system according to the present invention, for example, the first charging connection section and the first communication connection section of the electronic device are used in common, and the second charging connection section and the third communication connection section of the charger are used in common.

As still another aspect of the electronic device system according to the present invention, for example, the charger is equipped with a third charging connection section configured to be connected to the electronic device, the electronic device is equipped with a fourth charging connection section configured to be connected to the external charger and a second charging power output section configured to output the charging power supplied from the fourth charging connection section to the secondary battery at a predetermined level, and the second charging power output section can output charging power to the secondary battery at least in the case that the first charging power output section does not output the predetermined current to the second charging connection section.

### Advantage of the Invention

The electronic device according to the present invention can judge whether the external charger electrically connected to the electronic device is the authorized (genuine) connection device and can also judge whether the applied voltage is suitable for the charging of the secondary battery. With these judgments, the charging of the secondary battery using the authorized charger can be performed safely, whereby the life of the secondary battery can be extended and the electrical protection of the electronic device incorporating the secondary battery can be attained. Furthermore, the charger according to the present invention can judge whether the electronic device electrically connected to the charger is the authorized (genuine) connection device; in the case that the electronic device is not the authorized electronic device, the charger does not apply voltage, whereby the charger can be protected electrically. Moreover, with the electronic device system according to the present invention, the electronic device and the charger can perform mutual authentication, whereby the entire electronic device system can be protected electrically.

### BRIEF DESCRIPTION OF THE DRAWINGS

FIG. 1 is a block diagram showing an example of a first embodiment of an electronic device, a charger and an electronic device system according to the present invention;

FIG. 2 is a flow chart showing an example of authentication according to the first embodiment;

FIG. 3 is a flow chart showing an example of the authentication of the charger according to the first embodiment;

FIG. 4 is an explanation table showing examples of steps at which judgments are made as to whether the electronic device, the charger and the electronic device system according to the first embodiment are in chargeable states;

FIG. 5 is a block diagram showing an example of a second embodiment of the electronic device, the charger and the electronic device system according to the present invention;

FIG. 6 is a flow chart showing an example of charging according to the second embodiment;

FIG. 7 is a conceptual view explaining an example of charging according to the second embodiment using graphs and a table;

FIG. 8 is a table in which the second embodiment is compared with a conventional technology;

FIG. 9 is a block diagram showing a third embodiment of the electronic device, the charger and the electronic device system according to the present invention;

FIG. 10(a) is a block diagram showing an example of a secondary battery according to the third embodiment, and FIG. 10(b) is a conceptual view showing the internal impedance of the secondary battery;

FIG. 11 is a graphic conceptual view showing an example of the charged state according to the second embodiment in comparison with the third embodiment;

FIG. 12 is a graphic conceptual view showing an example of the charged state after voltage correction according to the third embodiment was performed;

FIG. 13 is a graphic conceptual view showing the positions at which step charging according to the third embodiment is performed, the positions being specifically indicated using broken line arrows;

FIG. 14 is a graphic conceptual view showing specific numerical examples in the step charging according to the third embodiment.

FIG. 15 is a flow chart showing an example of a flow in the electronic device and the charger including the step charging according to the third embodiment; and

FIG. 16 is a flow chart showing an example of a flow in the step charging according to the third embodiment.

### MODE FOR CARRYING OUT THE INVENTION

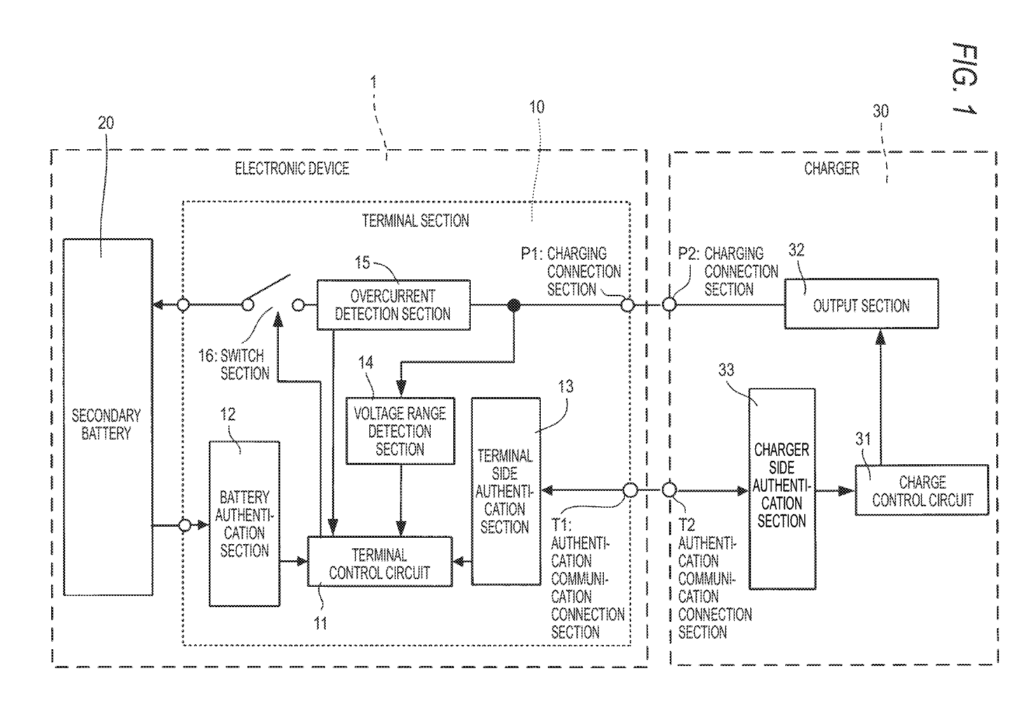

Preferred embodiments of an electronic device, a charger and an electronic device system according to the present invention will be described below in detail on the basis of FIGS. 1 to 16.

### First Embodiment

FIG. 1 is a block diagram showing a first embodiment of the electronic device, the charger and the electronic device system according to the present invention.

An electronic device 1 includes a terminal section 10 and a secondary battery 20 built in the electronic device 1 and detachably mounted on the terminal section 10. The electronic device 1 may be mobile devices being operated by the secondary battery 20, for example, mobile phones, such as smart phones; mobile terminals, such as tablets; digital cameras; portable personal computers; and wireless apparatuses. The terminal section 10 is equipped with a terminal control circuit 11, a battery authentication section 12, a terminal side authentication section 13, a voltage range detection section 14, an overcurrent detection section 15, and a switch section 16. Furthermore, the terminal section 10 is equipped with a charging connection section P1 and an authentication communication connection section T1 for electrical connection to a charger 30 described later.

The terminal control circuit 11 is, for example, equipped with a microprocessor for processing, controlling and judging signals coming from the above-mentioned configuration sections provided in the terminal section 10 and for transmitting command signals, and the circuit serves as a protection control circuit so that quick charging for the secondary battery 20 can be performed safely. The battery authentication section 12 acquires authentication data from the secondary battery 20 electrically connected to the terminal section 10 and judges whether the secondary battery 20 is suitable as a battery for use in the electronic device 1. The terminal side authentication section 13 acquires authentication data from the external charger 30 electrically connected to the terminal section 10 via the authentication communication connection section T1 and judges whether the charger 30 is suitable as a connection device for use in the electronic device 1.

The above-mentioned authentication data may be, for example, data which is transmitted at constant intervals and according to which a judgment can be made as to whether the secondary battery 20 and the charger 30 are the authorized connection devices for the terminal section 10, or may be enhanced encryption data, such as random numbers formed by a predetermined algorithm. The authentication data indicating the authorized (genuine) connection devices is hereafter referred to as predetermined data for better understanding of explanation. Furthermore, the data to be transmitted from the charger 30 to the terminal section 10 is referred to as first data, the data to be transmitted from the terminal section 10 to the charger 30 is referred to as second data, and the data to be transmitted from the secondary battery 20 to the terminal section 10 is referred to as third data.

The voltage range detection section 14 detects the voltage of the charging connection section P1 electrically connected to the charger 30 and transmits the measured voltage value to the terminal control circuit 11. The terminal control circuit 11 judges whether the voltage value is within a predetermined range (for example, 5 V) and at the same time also judges whether the voltage is in an overvoltage state. The overcurrent detection section 15 detects the value of the current flowing through the charging connection section P1 and transmits the measured current value to the terminal control circuit 11, and the terminal control circuit 11 judges whether the current value is within a predetermined range (for example, 4 A) and at the same time also judges whether the current is in an overcurrent state. Furthermore, if the current is not in an overcurrent state, a current equal to or more than a predetermined current can be passed. Although it has been described that the judgments are made by the terminal control circuit 11, the voltage range detection section 14 and the overcurrent detection section 15 may make judgments and may make notifications to the terminal control circuit 11 in the case that the voltage and the current are outside the predetermined ranges including overvoltage and overcurrent.

The switch section 16 is electrically connected to the charging connection section P1 and the secondary battery 20 and is turned on and off by the commands of the terminal control circuit 11, whereby the conduction/shut-off switching between the charging connection section P1 and the secondary battery 20 can be done. In other words, the terminal control circuit 11 judges authentication data and value data transmitted from the respective configuration sections, and in the case that the terminal control circuit 11 judges that safety is ensured according to the respective data when the charging of the secondary battery 20 is started, the terminal control circuit 11 turns on the switch section 16. As a result, the charging connection section P1 connected to the charger 30 becomes conductive to the secondary battery 20. Moreover, in the case that the terminal control circuit 11 judges that the authentication is false or judges that the voltage or the current is in an overvoltage state or an overcurrent state, the terminal control circuit 11 turns off the switch section 16 to stop or prohibit the charging operation, thereby shutting off the electrical connection between the charging connection section P1 and the secondary battery 20.

In the above-mentioned configuration of the terminal section 10, functions relating to the charging of the secondary battery 20 are mainly described, and the other configuration portions, such as the display section and the input section thereof, are omitted; however, the configuration of the terminal section 10 is not limited to the above-mentioned configuration.

The secondary battery 20 is, for example, a secondary battery, such as a lithium-ion secondary battery or a nickel-hydrogen secondary battery, and the battery is charged by the electric power supplied from the external charger 30 or the like and operates various configurations provided in the terminal section 10 by using the charged electric power.

The detachable charger 30 electrically connected to the electronic device 1 is equipped with a charge control circuit 31, an output section 32 and a charger side authentication section 33 and is also equipped with a charging connection section P2 and an authentication communication connection section T2 as in the case of the electronic device 1. Furthermore, the charger 30 is equipped with a plug that is electrically connectable to external commercial AC power, a USB port electrically connectable to a personal computer or the like, although these are not shown.

The charge control circuit 31 is equipped with a microprocessor for controlling the output section 32 of the charger 30 and for judging signals coming from the charger side authentication section 33, whereby electric power capable of charging the secondary battery 20 is supplied and appropriate electric power is supplied while the state of charging is grasped. The output section 32 outputs electric power to be supplied to the secondary battery 20 according to a command from the charge control circuit 31. As the quick charging method controlled by the charge control circuit 31, various methods, such as the −ΔV control charging method, dT/dT control charging method and step control charging method, are available, and these methods can be selected according to the performance of the secondary battery 20, the purpose of use of the electronic device 1, etc.

The charger side authentication section 33 is electrically connected to the electronic device 1 and receives the second data serving as authentication data transmitted from the electronic device 1 through the authentication communication connection section T2 that is capable of receiving the second data, and judges whether the data is predetermined data indicating that the electronic device 1 is the authorized electronic device recognized by the charger 30. The second data may be, for example, data which is transmitted at constant intervals and according to which a judgment can be made as to whether the electronic device 1 is the authorized connection device for the charger 30, or may be enhanced encryption data, such as random numbers formed by a predetermined algorithm. Furthermore, the first data and the second data are authenticated mutually, whereby the electronic device 1 and the charger 30 can be authenticated mutually.

At the charging connection section P1 and the authentication communication connection section T1 of the electronic device 1 and the charging connection section P2 and the authentication communication connection section T2 of the charger 30, the charging connection sections P1 and P2 are electrically connected to each other, and the authentication communication connection sections T1 and T2 are electrically connected to each other. Furthermore, the charging connection section P1 and the authentication communication connection section T1 on the side of the electronic device 1 may be used in common as a single connection section, and the charging connection section P2 and the authentication communication connection section T2 on the side of the charger 30 may be used in common as a single connection section. The common use of the connection sections simplifies the configuration and may lead to cost reduction. Moreover, each of them is a terminal and can be configured, for example, as a three-terminal regulator separately provided with a ground terminal.

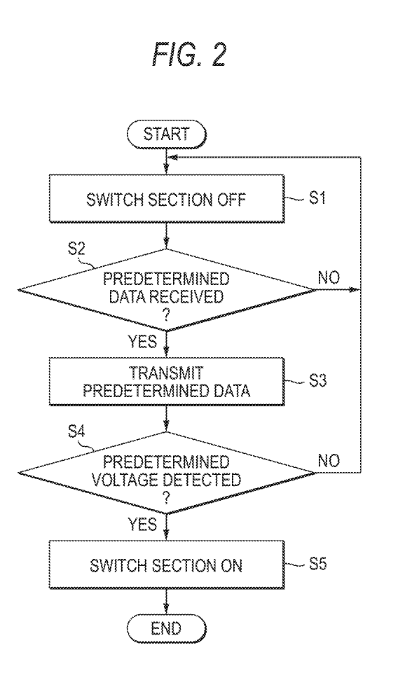

FIG. 2 is a flow chart showing an example of authentication of the electronic device 1.

At first, the switch section 16 of the electronic device 1 is in its off state (at step S1). When the charger 30 is connected to the electronic device 1, the terminal side authentication section 13 judges whether the first data acquired from the charger 30 via the authentication communication connection section T1 is the predetermined data according to which it is possible to judge that the charger 30 is an appropriate external connection device (for example, a genuine connection device) (at step S2). In the case that the terminal side authentication section 13 judges that the first data is the predetermined data (Y at step S2), the terminal side authentication section 13 transmits the second data to the charger 30 (at step S3).

Next, the terminal control circuit 11 judges whether the voltage supplied from the charger 30 to the charging connection section P1 of the electronic device 1 has been detected as an appropriate predetermined voltage for charging the secondary battery 20 (at step S4). In the case that the terminal control circuit 11 judges that the voltage is the predetermined voltage (Y at step S4), the terminal control circuit 11 turns on the switch section 16 (at step S5). In the case that the terminal side authentication section 13 judges that the first data is not the predetermined data (N at step S2) and in the case that the terminal control circuit 11 judges that the voltage is not the predetermined voltage (N at step S4), the terminal control circuit 11 maintains the switch section 16 in its off state.

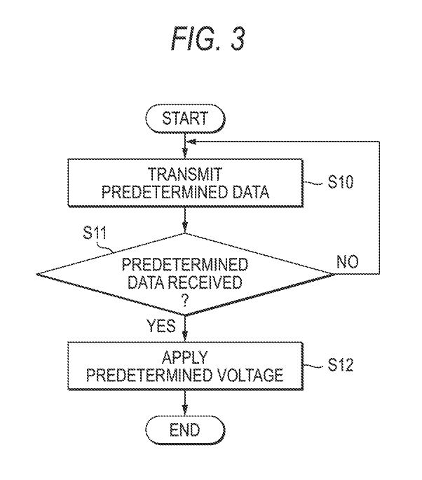

FIG. 3 is a flow chart showing an example of the authentication of the charger 30.

When connected to the electronic device 1, the charger 30 transmits the first data for authentication (the predetermined data) from the charger side authentication section 33 to the electronic device 1. The first data is used to make a judgment as to whether the predetermined data has been received at step S2 shown in FIG. 2. Next, the charger side authentication section 33 of the charger 30 judges whether the second data acquired from the electronic device 1 via the authentication communication connection section T2 is the predetermined data according to which a judgment can be made as to whether the electronic device 1 is an appropriate external connection device (at step S11). The second data is the data transmitted at step S3 shown in FIG. 2.

In the case that the charger side authentication section 33 judges that the second data is the predetermined data (Y at step S11), the predetermined voltage appropriate for charging is applied to the electronic device 1. In other words, a notice indicating that the authentication is completed at the charger side authentication section 33 is given to the charge control circuit 31, and the charge control circuit 31 instructs the output section 32 to supply the predetermined voltage appropriate for charging, and the output section 32 applies the predetermined voltage to the charging connection section P2 (at step S12). In the case that the charger side authentication section 33 does not receive the predetermined data (N at step S11), the procedure returns to step S10).

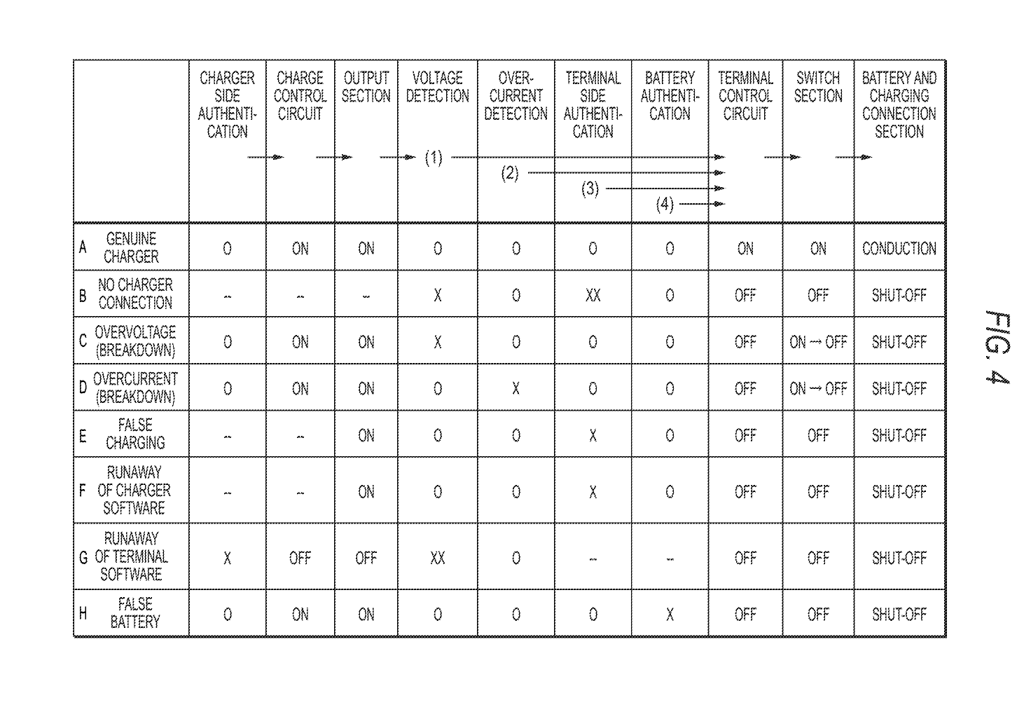

FIG. 4 is an explanation table showing examples of steps at which judgments are made as to whether the state is a chargeable state. On the basis of this explanation table, specific protection actions will be described in detail. Specific situations (cases) are listed in the respective rows of the explanation table, and items to be authenticated, detected and controlled are listed in the respective columns thereof.

Case A (genuine charger): this is a case in which a genuine charger 30 is connected to the electronic device 1. When the genuine charger 30 is connected to the electronic device 1, the charger side authentication section 33 judges whether the electronic device 1 is the authorized electronic device on the basis of the second data. When it is authenticated that the second data is the predetermined data, the charge control circuit 31 transmits the voltage value and the current value required for charging to the output section 32, and the output section 32 outputs electric power to the charging connection section P2. The voltage range detection section 14 detects the voltage supplied from the charging connection section P1, the detection is notified to the terminal control circuit 11, and the terminal control circuit 11 judges that the predetermined voltage has been applied (refer to (1) in the table). The overcurrent detection section 15 detects the value of the current flowing in the charging connection section P1, the detection is notified to the terminal control circuit 11, and the terminal control circuit 11 judges that the current value is the predetermined current value (refer to (2) in the table).

In the case that the first data transmitted from the charger 30 is the predetermined data, the terminal side authentication section 13 authenticates that the charger 30 is genuine, and the authentication is notified to the terminal control circuit 11 (refer to (3) in the table). In the case that the third data transmitted from the secondary battery 20 is the predetermined data, the battery authentication section 12 authenticates that the secondary battery 20 is the authorized connection device, and the authentication is notified to the terminal control circuit 11 (refer to (4) in the table). In the case that all the signals ((1) to (4)) are OK, the terminal control circuit 11 turns on the switch section 16, whereby the connection between the secondary battery 20 and the charging connection section P1 becomes conductive, and the charging of the secondary battery 20 is started.

Case B (no charger connection): this is a case in which the charger 30 is not connected to the electronic device 1. In the case that the charger 30 is not connected, voltage detection at the voltage range detection section 14 cannot be performed and authentication at the terminal side authentication section 13 cannot be performed, whereby the switch section 16 is in its off state, the connection between the secondary battery 20 and the charging connection section P1 is set to the shut-off state, and charging is not performed. In the table, voltage detection is “x” and terminal-side authentication is “xx” due to the causal relationship. However, if the charging connection section P1 being bare (exposed) becomes dirty or makes contact with a foreign substance from the outside, there is a risk of causing short-circuit; nevertheless, since the switch section 16 is in its off state, the terminal section 10 and the secondary battery 20 are electrically protected.

Case C (overvoltage) and Case D (overcurrent): these are cases in which overvoltage and overcurrent have been detected. In the case that the terminal control circuit 11 judges that the voltage value detected by the voltage range detection section 14 and the current value detected by the overcurrent detection section 15 exceed predetermined ranges and are abnormal, the terminal control circuit 11 turns off the switch section 16 immediately, thereby making the connection between the secondary battery 20 and the charging connection section P1 to the shut-off state. In Case C, voltage detection is “x”, and in Case D, overcurrent detection is “x”, whereby the switch section 16 is switched “from ON to OFF”.

Case E (false charging): this is a case in which charging using an unauthorized device different from the authorized (genuine) charger 30 is attempted. In this case, since the first data received by the terminal side authentication section 13 is not the predetermined data (refer to terminal side authentication “x”), the terminal control circuit 11 does not turn on the switch section 16, whereby the connection between the secondary battery 20 and charging connection section P1 is shut off and charging is not performed.

Case F (runaway of charger software) and Case G (runaway of terminal software): these are cases in which software is abnormal, for example, runaway of software has occurred. Although software for safe charging is installed in the terminal control circuit 11 and the charge control circuit 31, the software may cause abnormality sometimes. In such a case, the authentication by the terminal side authentication section 13 and the authentication by the charger side authentication section 33 are not performed (refer to terminal authentication and charger side authentication “x”), and the terminal control circuit 11 does not turn on the switch section 16, whereby the connection between the secondary battery 20 and the charging connection section P1 is shut off and charging is not performed. Furthermore, in Case G, electric power is not supplied from the output section 32, whereby voltage cannot be detected at the voltage range detection section 14 (refer to voltage detection “xx”).

Case H (false battery): this is a case in which an inappropriate (unauthorized) secondary battery 20 is connected to the terminal section 10 of the electronic device 1 as the secondary battery 20. In the case that the battery authentication section 12 judges that the third data is not the predetermined data or that the third data is not transmitted (refer to battery authentication “x”), the terminal control circuit 11 does not turn on the switch section 16, whereby the connection between the secondary battery 20 and the charging connection section P1 is shut off and charging is not performed.

How the configurations of the terminal section 10 and the charger 30 operate to safely charge the secondary battery 20 has been described in detail on the basis of the explanatory drawing of FIG. 4; however, the operations are not particularly limited to the contents described above. It is necessary to monitor the heat generation in the charge control circuit 31, the charged state of the secondary battery 20, etc. during quick charging, and it is possible to adopt various protection circuits and protection programs as necessary to safely perform charging.

### Second Embodiment

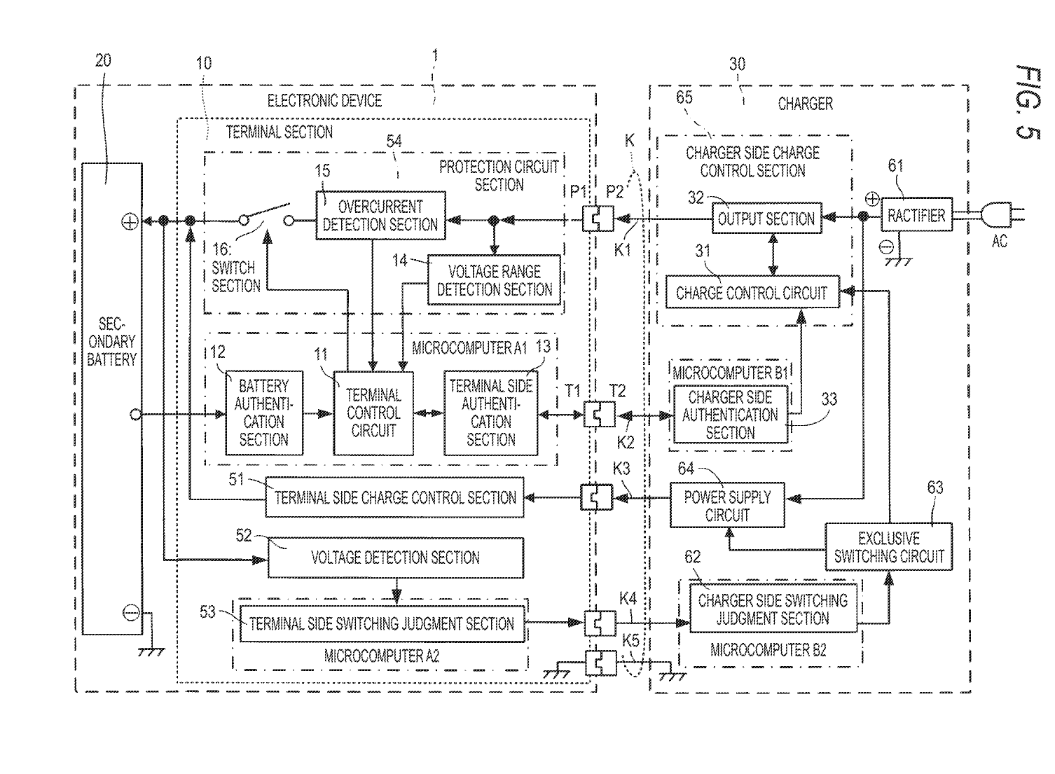

FIG. 5 is a block diagram showing a second embodiment of the electronic device, the charger and the electronic device system according to the present invention. In the second embodiment, the same configurations as those in the first embodiment are designated by the same reference numerals and their descriptions are omitted, and only the differences will be described in detail. Furthermore, in contrast to the first embodiment, in the second embodiment, details concerning quick charging control and charging circuit will be described.

It is generally known that circuits for controlling voltage and current are not provided on the side of the terminal section 10 and that a charging circuit is mounted on the side of the charger 30 as disclosed, for example, in Patent Document 1. However, since the distance between the charge control circuit 31 and the secondary battery 20 becomes long, it becomes difficult to accurately grasp the voltage of the secondary battery 20 because of the resistance of a cord (cable) K described later. Moreover, if charging is performed in a state in which the voltage of the secondary battery 20 cannot be grasped accurately, it becomes difficult to have an appropriate charged state depending on the state of the voltage of the secondary battery 20, and there is a possibility that trouble, such as acceleration in the performance deterioration of the secondary battery 20 due to the application of excessive voltage, may occur. In the second embodiment, functions relating to charge control are also provided on the side of the electronic device 1, appropriate charging depending on the voltage of the secondary battery 20 is performed, heat generation due to the charging from the electronic device 1 is minimized, whereby both quick charging and safety are aimed to be achieved.

According to the second embodiment, a terminal side charge control section 51, a voltage detection section 52 and a terminal side switching judgment section 53 are specifically shown in the terminal section 10 of the electronic device 1, and the voltage range detection section 14, the overcurrent detection section 15 and the switch section 16 described in detail in the first embodiment are described as a protection circuit section 54. Furthermore, since the terminal control circuit 11, the battery authentication section 12 and the terminal side authentication section 13 are equipped with a microprocessor, they are sometimes described as a microcomputer A1, and the terminal side switching judgment section 53 equipped with a microprocessor is also sometimes described as a microcomputer A2. Although the microcomputer A1 and the microcomputer A2 have been described separately, they may function as a single microcomputer.

The charger 30 is an AC adapter equipped with a plug that is electrically connectable to the external commercial AC power source and is equipped with a rectifier 61, a charger side switching judgment section 62, an exclusive switching circuit 63 and a power supply circuit 64; these are shown specifically. Furthermore, the charge control circuit 31 and the output section 32 described in detail in the first embodiment are described as a charger side charge control section 65, and the charger side authentication section 33 equipped with a microprocessor is described as a microcomputer B1, and the charger side switching judgment section 62 is described as a microcomputer B2.

Although the microcomputer B1 and the microcomputer B2 have been described separately, they may function as a single microcomputer.

The terminal side charge control section 51 controls supplementary charging and constant voltage charging for the secondary battery 20 as described later. The voltage detection section 52 acquires battery information, such as the voltage and temperature of the secondary battery 20, thereby also serving as, for example, a battery monitoring circuit. The terminal side switching judgment section 53 acquires the battery information transmitted from the voltage detection section 52, judges whether the battery information is information required to operate the exclusive switching circuit 63, and transmits the information using digital signals having less deterioration and less erroneous transmission via, for example, an 12C serial bus. These signals include, for example, commands for quick charging and the like performed on the side of the charger 30, in addition to the judgment information. Furthermore, the electrical connection between the terminal section 10 and the secondary battery 20 is made using terminals provided on the side of the secondary battery 20. The terminals of the secondary battery 20 are a positive terminal (+ terminal), an authentication terminal and a negative terminal (− terminal) arranged in this order from above in the figure.

The rectifier 61 is an electric power converter for converting (rectifying) alternating current power (AC) into direct current power (DC) and supplies the electric power to the output section 32 and the power supply circuit 64. Upon receiving the digital signals from the terminal side switching judgment section 53, the charger side switching judgment section 62 judges whether the charge control circuit 31 and the power supply circuit 64 are turned on or off, and issues a command for turning on or off the exclusive switching circuit 63. Upon receiving the signal from the charger side switching judgment section 62, the exclusive switching circuit 63 turns on or off the charge control circuit 31 and the power supply circuit 64.

The electronic device 1 is electrically connected to the charger 30 using a cord K in which a plurality of conductive wires K1, K2, . . . are bundled. The charging connection section P1 of the electronic device 1 and the charging connection section P2 of the charger 30 are electrically connected to each other using the conductive wire K1, and voltage and current are supplied; the authentication communication connection section T1 of the electronic device 1 and the authentication communication connection section T2 of the charger 30 are electrically connected to each other using the conductive wire K2, and authentication signals are transmitted. The voltage supply from the power supply circuit 64 to the terminal side charge control section 51 is performed via the conductive wire K3, and the signal transmission from the terminal side switching judgment section 53 to the charger side switching judgment section 62 is performed via the conductive wire K4. These electrical connections are made, for example, using pin connectors or USB connector provided at the tip ends of the cord K. The conductive wire K5 is connected to the grounds of the electronic device 1 and the charger 30.

Although the charge control circuit 31 and other circuits are mounted on the side of the charger 30 to avoid heat generation in the terminal section 10 during charging, the cord K is required to electrically connect the terminal section 10 to the charger 30, and the cord K has a resistance value. For example, when it is assumed that the cord K has a resistance of 1.0Ω, a loss of 4.0 V occurs at 4.0 A, and the charge voltage of 4.34 V serving as the value not to be exceeded appears to be 8 V, whereby charge control may not be performed safely. Since the voltage detection section 52 for monitoring the voltage of the secondary battery 20 at all times and the terminal side charge control section 51 capable of performing charging at a very small current are provided on the side of the electronic device 1 in the second embodiment, appropriate charging corresponding to the voltage of the secondary battery 20 can be performed.

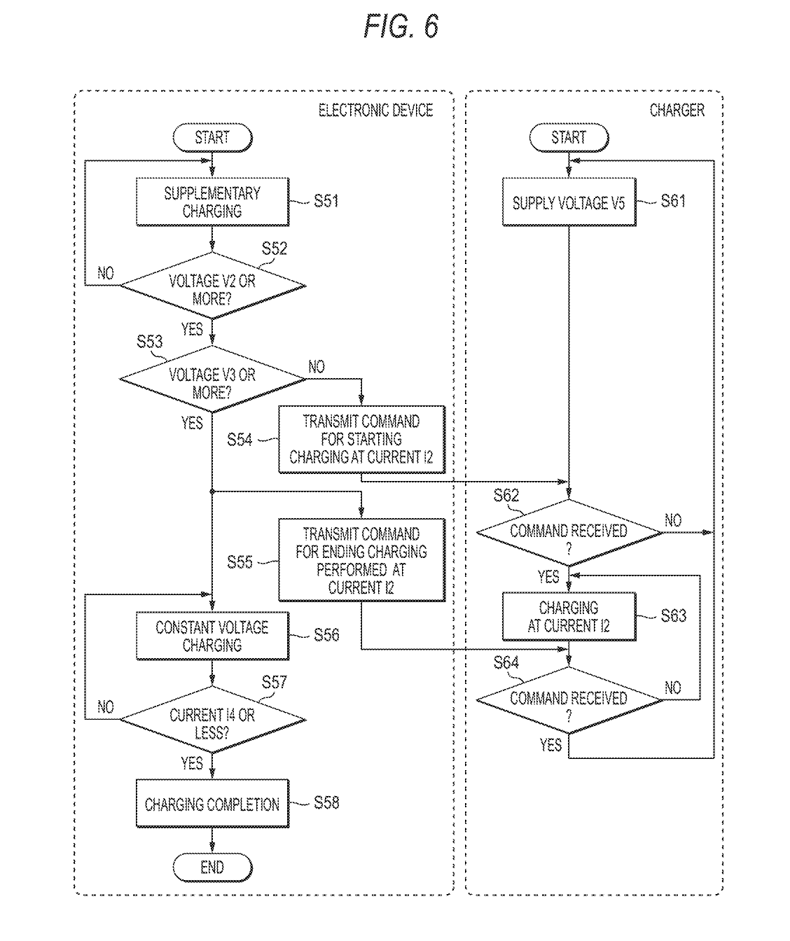

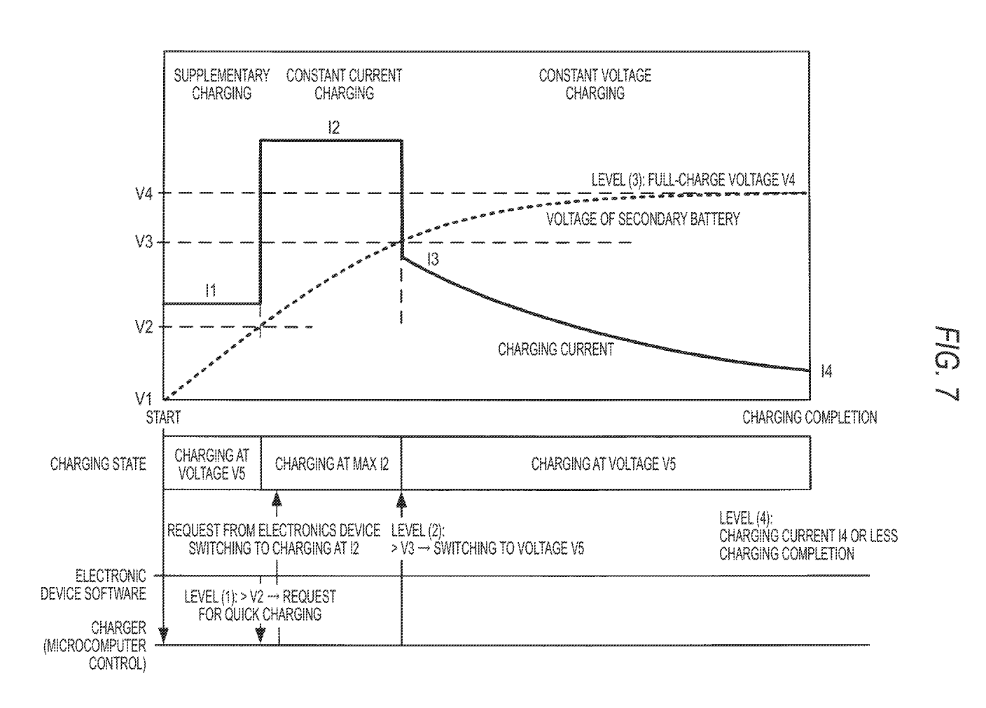

FIG. 6 is a flow chart showing an example of charging according to the second embodiment, and FIG. 7 is a conceptual view explaining an example of charging using graphs and a table. Operations according to the second embodiment will be described in detail using FIGS. 6 and 7.

The left flow chart in FIG. 6 shows the flow of the operation of the electronic device 1, and the right flow chart shows the flow of the operation of the charger 30. Quick charging according to the second embodiment has three phases: “supplementary charging” (step S51 to step S52), “constant current charging” (Yes at step S52 to step S55) and “constant voltage charging” (step S56 to step S58). Furthermore, in the graphs shown on the upper side of FIG. 7, the graph drawn using thick straight lines and a thick curve indicates the change in the value of the current flowing in the secondary battery 20, and the graph drawn using a broken-line curve indicates the change in the value of the voltage of the secondary battery 20. The table shown on the lower side indicates operations in the respective phases of charged state, electronic device software and charger (microcomputer control) in this order from above. The charged state indicates the voltage and current to be supplied depending on the charged state of the secondary battery 20, and the electronic device software indicates commands to be issued by the terminal side switching judgment section 53 of the electronic device 1. In addition, the charger (microcomputer control) indicates the operation of the charger 30 and indicates the flow of the signal to be transmitted from the terminal side switching judgment section 53 to the charger side switching judgment section 62. In the graphs and table shown in FIG. 7, the three phases of “supplementary charging,” “constant current charging” and “constant voltage charging” appear in this order in time series from the left side.

<Phase 1: Supplementary Charging>

Phase 1 is supplementary charging that is performed in the case that the voltage of the secondary battery 20 has not reached the voltage at which quick charging is possible.

The voltage detection section 52 monitors the voltage of the secondary battery 20; when the state of the secondary battery 20 approaches the state of empty charge, such as an empty charge voltage V1 (for example, 2.7 V) at which charging is necessary, the voltage detection section 52 notifies the user that charging is necessary via the display monitor or the like (not shown) of the electronic device 1. The user electrically connects the electronic device 1 to the charger (AC adapter) 30 using the cable K, whereby charging starts (at step S51). When the electronic device 1 is connected to the charger 30, the voltage value of the secondary battery 20 acquired by the voltage detection section 52 is transmitted to the terminal side switching judgment section 53, and the terminal side switching judgment section 53 judges whether the voltage value is equal to or less than a quick charging start voltage V2 (for example, 3.4 V) described later (at step S52).

The judgment information of the terminal side switching judgment section 53 is transmitted to the charger side switching judgment section 62 using a digital signal; in the case that the voltage value of the secondary battery 20 is equal to or less than 2 V (No at step S52), the charger side switching judgment section 62 issues a command to the exclusive switching circuit 63 to turn on the power supply circuit 64. Then, the voltage having a voltage value V5 (for example, 5 V) is supplied from power supply circuit 64 to the terminal side charge control section 51 (constant voltage supply). The terminal side charge control section 51 performs constant current control in which a constant small current I1 (for example, 0.1 A) is supplied, as shown in the graph in FIG. 7.

In the case that the voltage value of the secondary battery 20 is equal to or less than V2, the charger 30 performs constant voltage supply at the voltage V5 for the electronic device 1; however, constant current control is performed in the terminal section 10 at the constant I1, whereby performance deterioration in the secondary battery 20 can be prevented. In addition, since charging is performed using the small current I1, heat generation on the side of the electronic device 1 is small, whereby the heating load to the electronic device 1 can be reduced. The above-mentioned constant voltage supply simply means that the constant voltage V5 (for example, 5 V) is supplied from the charger 30 to the electronic device 1. Furthermore, the above-mentioned constant current control means that control is performed at the constant current I1 (for example, 0.1 A) or I2 (for example, 4 A), described later, depending on the voltage of the secondary battery 20 while the voltage is monitored.

Although it has been described above that the judgment information of the terminal side switching judgment section 53 is transmitted to the charger side switching judgment section 62 using a digital signal, in the case that the voltage value of the secondary battery 20 is equal to or less than V2, the terminal side switching judgment section 53 does not operate sometimes. It may be possible that the charger side switching judgment section 62 judges that no signal is transmitted from the terminal side switching judgment section 53 and transmits a command for turning on the power supply circuit 64 to the exclusive switching circuit 63.

<Phase 2: Constant Current Charging>

Phase 2 is constant current charging in which the charger 30 starts quick charging at the constant current I2 (for example, 4.0 A) in the case that the charger side switching judgment section 62 judges that the voltage of the secondary battery 20 is equal to or more than the quick charging start voltage V2 (Yes at step S52).

Upon judging that the voltage of the secondary voltage 20 is equal to or less than a constant voltage charging start voltage V3 (for example, 4.25 V) (No at step S53), the terminal side switching judgment section 53 transmits a command for starting the charging at the current I2 to the charger side switching judgment section 62 (at step S54). On the side of the charger 30, electric power is supplied at the constant voltage V5 (at step S61), and the charger side switching judgment section 62 judges whether the command from the terminal side switching judgment section 53 has been received (at step S62). In the case that the charger side switching judgment section 62 judges that the command has been received (Yes at step S62), the charger side switching judgment section 62 issues a command to the exclusive switching circuit 63, thereby turning off the power supply circuit 64 and turning on the charge control circuit 31. When the charge control circuit 31 is turned on, constant current control, in which the current I2 flows from the output section 32 and passes through the protection circuit section 54 of the terminal section 10, is performed for the secondary battery 20 (at step S63). The above-mentioned quick charging corresponds to the level (1) described in the table of FIG. 7; since the voltage has exceeded the voltage V2, the terminal side switching judgment section 53 issues a quick charging request to the side of the charger 30, and the side of the charger 30 receives the request from the terminal section 10, whereby the charging is switched to the charging at the current I2.

Constant current charging means quick charging in which constant current control at the current I2 is performed on the side of the charger 30 in a period in which the voltage of the secondary battery 20 is equal to or less than V3 (for example, 4.25 V) and constant voltage supply is performed at the voltage V5 for the secondary battery 20. Furthermore, in constant current charging, quick charging is made possible by passing the current I2 that is larger than the current I1 in Phase 1: supplementary charging. The above-mentioned voltage V3 is sometimes described as a predetermined voltage or a first voltage value, and the voltage V2 lower than the voltage V3 is sometimes described as a second voltage value.

In Phase 2, it is important that quick charging should be started when the voltage of the secondary battery 20 has reached the chargeable voltage V2 and should be stopped when the voltage has reached the predetermined voltage V3 to prevent the charging performance of the secondary battery 20 from being deteriorated as much as possible. Appropriate quick charging can be performed by monitoring the voltage of the secondary battery 20 at the terminal section 10 at all times and by performing feedback.

<Phase 3: Constant Voltage Charging>

Phase 3 is constant voltage charging in which control is performed so that the voltage of the secondary battery 20 converges to a constant voltage, that is, a full-charge voltage V4 (for example, 4.34 V), in the case that the voltage of the secondary voltage 20 becomes equal to or more than the constant voltage charging start voltage V3 (for example, 4.25 V) by quick charging (Yes at step S53). Phase 3 is characterized in that the charging current is lowered in accordance with the voltage of the secondary battery 20.

In the case that the terminal side switching judgment section 53 judges that the voltage of the secondary battery 20 is equal to or more than V3 (Yes at step S53), the terminal side switching judgment section 53 transmits a command for ending the quick charging performed at the current I2 to the charger side switching judgment section 62 (at step S55). Upon receiving the command (Yes at step S64), the charger side switching judgment section 62 transmits a command to the exclusive switching circuit 63, thereby turning off the charge control circuit 31 and turning on the power supply circuit 64, and the charger 30 performs constant voltage supply at the voltage V5 (at step S61), whereby constant voltage charging control on the side of the electronic device 1 is performed (at step S56). This constant voltage charging corresponds to the level (2) described in the table of FIG. 7. The constant voltage charging starts at a current I3 (for example, 1 A) as indicated in the graph of FIG. 7. The voltage detection section 52 of the terminal section 10 monitors the voltage of the secondary battery 20 at all times, and the charging current is lowered while the voltage of the secondary battery 20 is kept within the range of not exceeding the full-charge voltage V4 (for example, 4.25 V). Then, in the case that the terminal section 10 judges that the charging current is equal to or less than I4 (for example, 50 mA) (Yes at step S57), the charging is completed (at step S58). The full-charge voltage V4 corresponds to the level (3) of FIG. 7, and the charging current I4 corresponds to the level (4) of FIG. 7.

In Phase 3, it is important that the voltage must not exceed the full-charge voltage V4. Hence, the voltage detection section 52 monitors the voltage of the secondary battery 20 at all times, and the terminal section 10 controls the current in real time. In other words, high priority is given to the accuracy of the charge control at the terminal section 10, and current control is performed so that the current is lowered from the current I3 that is lower than the current I2 used at the time of the quick charging to the smaller current I4, whereby the heat generation by the charging of the electronic device 1 can be suppressed.

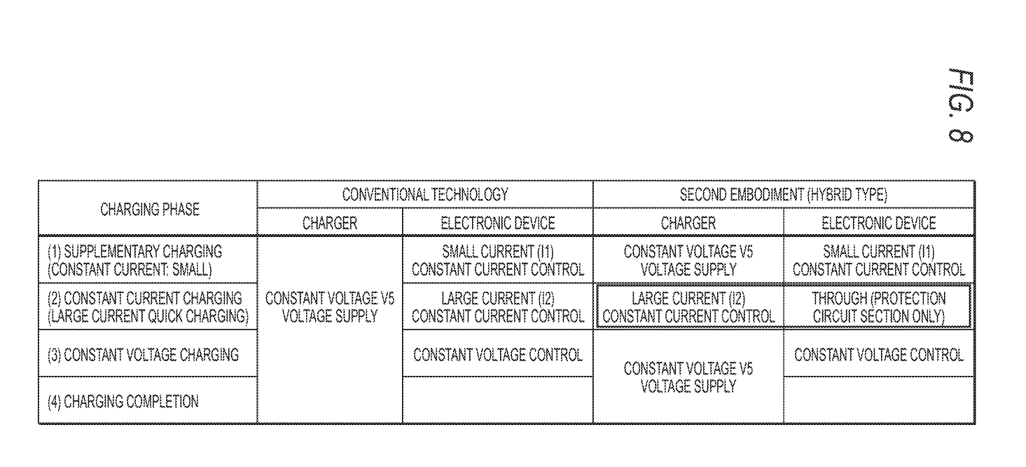

FIG. 8 is a table in which a conventional technology is compared with the second embodiment. The conventional technology is a traditional general technology (well-known art), for example, included in Patent Document 1, in which control is performed entirely on the side of the electronic device 1.

The second embodiment (hybrid type) is significantly different from the conventional technology in the constant current charging (large current quick charging) at the level (2) in Phase 2 wherein the constant current control at the large current I2 is performed on the side of the charger 30, and voltage and current are simply supplied only to the protection circuit section 54 on the side of the electronic device 1. In the case that charging is performed entirely at the electronic device 1 as in the conventional technology, the amount of heat generation, particularly in smart phones and the like, increases as the current value increases, and the temperature of the electronic device 1 may rise to its allowable temperature or higher. In the second embodiment, quick charging at large current is performed at the charger 30, and current control at small current, requiring higher accuracy, is performed at the electronic device 1, whereby the heat generation in the electronic device 1 can be suppressed. Furthermore, the voltage of the secondary battery 20 is monitored at all times in real time, and the current control is performed accurately on the side of the electronic device 1 on the basis of the battery information, whereby performance deterioration in the secondary battery 20 can be prevented.

### Third Embodiment

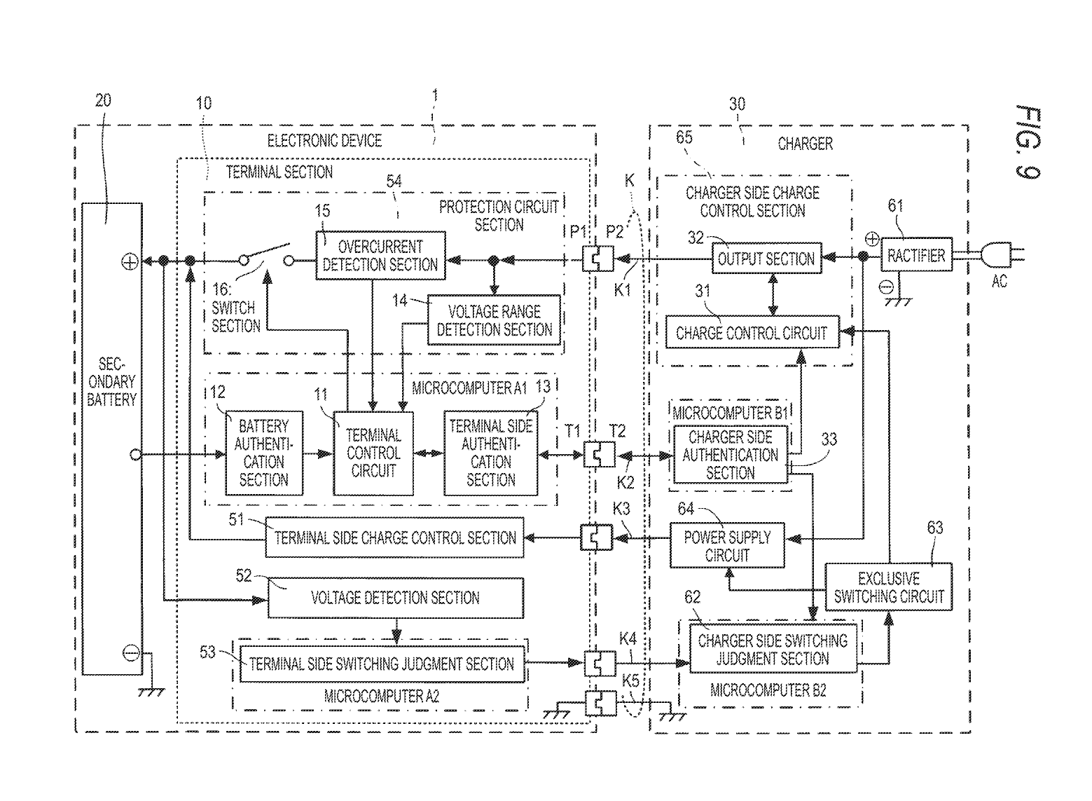

FIG. 9 is a block diagram showing a third embodiment of the electronic device, the charger and the electronic device system according to the present invention. In the third embodiment, the accuracy of the quick charging is made higher than that in the second embodiment. The same configurations as those in the second embodiment are designated by the same reference numerals and their descriptions are omitted.

A signal flowing path from the charger side authentication section 33 to the charger side switching judgment section 62 is added to the block diagram (see FIG. 5) according to the second embodiment. The reason for this addition is that the voltage V of the secondary battery 20 is monitored sequentially by the voltage detection section 52, the terminal side switching judgment section 53 and the charger side switching judgment section 62 in this order, and that a predetermined impedance R0 and an offset voltage Vs, described later, are calculated by the charger side authentication section 33 and notified to the charger side switching judgment section 62. On the basis of the voltage V of the secondary battery 20 and the offset voltage Vs, the charger side switching judgment section 62 raises the threshold value for the switching judgment to a threshold voltage and issues a command for operating the exclusive switching circuit 63.

In the first embodiment, at the charging connection section P1 and the authentication communication connection section T1 of the electronic device 1 and the charging connection section P2 and the authentication communication connection section T2 of the charger 30, the charging connection sections P1 and P2 are electrically connected to each other, and the authentication communication connection sections T1 and T2 are electrically connected to each other. In addition, it has been described in detail that the charging connection section P1 and the authentication communication connection section T1 on the side of the electronic device 1 may be used in common as a single connection section, and the charging connection section P2 and the authentication communication connection section T2 on the side of the charger 30 may be used in common as a single connection section. Also in the third embodiment, the charging connection section P1 and the authentication communication connection section T1 of the electronic device 1 may be used in common, and the charging connection section P2 and the authentication communication connection section T2 of the charger 30 may also be used in common. Moreover, although it has been described that the electronic device 1 and the charger 30 are electrically connected using the cable K, terminals (for example, metal terminals) may be electrically connected directly and mutually, instead of using the cable K.

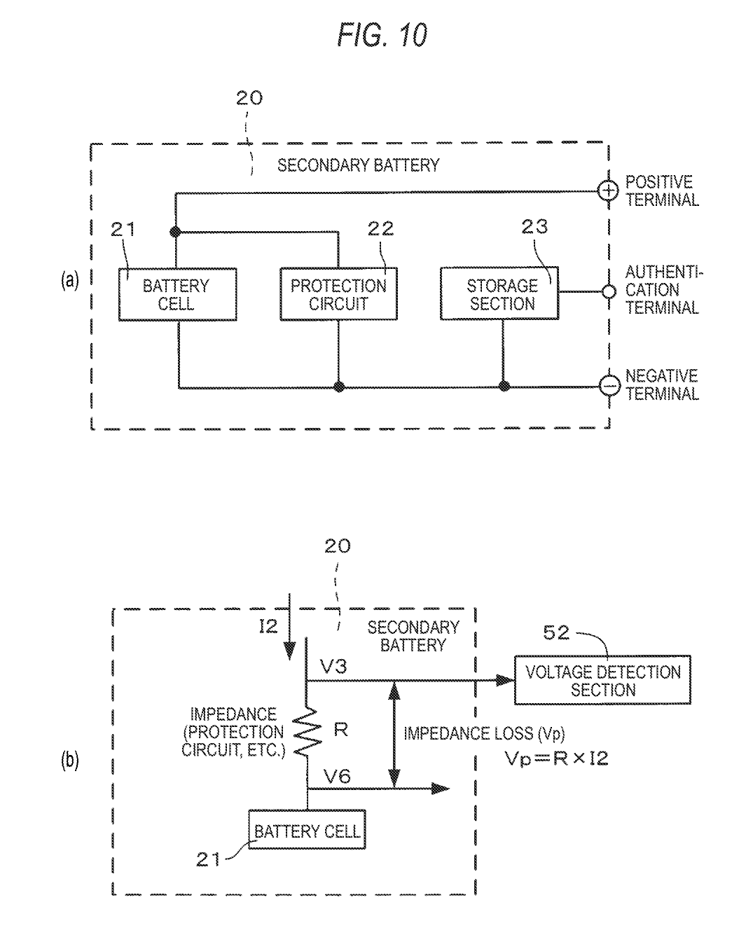

FIG. 10(a) is a block diagram showing the secondary battery 20, and FIG. 10(b) is a conceptual view showing the internal impedance of the secondary battery 20.

The secondary battery 20 is equipped with a battery cell 21 formed of a modularized cell, a protection circuit 22 composed of a switching element or the like to prevent the voltage of the battery cell 21 from rising abnormally, and a storage section 23 for holding the internal impedance R of the secondary battery 20. Furthermore, the storage section 23 also holds the type, the manufacturing number, etc. of the secondary battery 20. Moreover, as described in the second embodiment, the terminals of the secondary battery 20 includes a positive terminal (+ terminal), an authentication terminal and a negative terminal (− terminal) in this order from above in the figure. The detection of the internal impedance R is performed at the battery authentication section 12 at the same time as the acquisition of the type or the manufacturing number from the storage section 23. What is more, for example, it may be possible that the electronic device 1 automatically accesses the correspondence table between the type or the manufacturing number and the internal impedance R on the Internet and acquires the internal impedance R.

The internal impedance R is notified from the electronic device 1 to the charger 30. For example, in the case that the detection of the internal impedance R is performed at the battery authentication section 12, the notification is done from the battery authentication section 12 to the terminal control circuit 11 and the terminal side authentication section 13 in this order. Then, the notification is given to the side of the charger 30 via the authentication communication connection section T1 of the electronic device 1 and the authentication communication connection section T2 of the charger 30 and transmitted to the charger side authentication section 33, the charge control circuit 31 and the output section 32 in this order, and then the output current value in the phase of constant current charging is controlled. Then, for the electric power to be supplied to the electronic device 1 via the charging connection section P2 on the side of the charger 30, the charger 30 can perform constant current control so that the predetermined current value based on the internal impedance R is obtained.

Generally speaking, in the secondary battery 20, in addition to the battery cell 21 in the main body thereof, the protection circuit 22 for protecting the battery cell 21 is provided, whereby the internal impedance R caused by the battery cell 21, the protection circuit 22, the storage section 23, etc. is generated. An impedance loss Vp (for example, 0.4 V), that is, the product of the charging current I2 (for example, 4.0 A) flowing in the secondary battery 20 and the internal impedance R (for example, 100 mΩ), is generated by the internal impedance R (Vp=R×I2; see FIG. 10(b)). In other words, an error occurs between the voltage V3 of the secondary battery 20 detected by the voltage detection section 52 and the true voltage V6 of the battery cell 21 due to the internal impedance R.

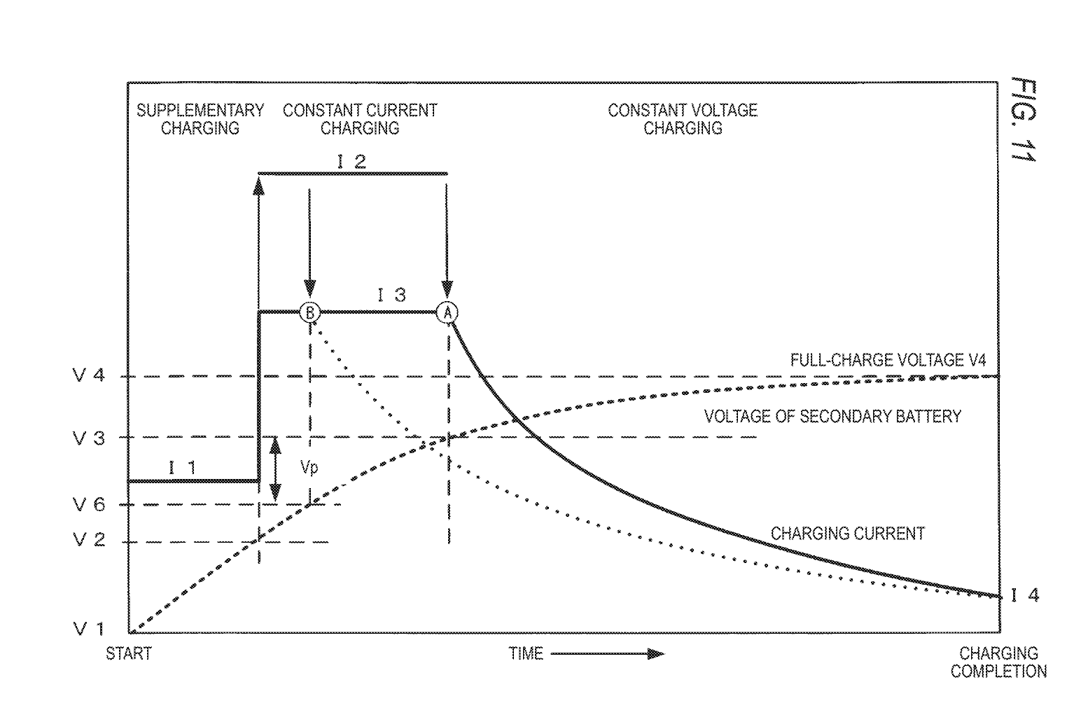

The relationship between the error in the voltage caused by the above-mentioned impedance loss Vp and the charged state will be described in detail referring to FIG. 11. FIG. 11 is a conceptual view showing an example of the charged state using graphs in which the scale of the current value I in the vertical direction is made different from that shown in FIG. 7 for better understanding of explanation. On the other hand, the voltage V and the current value I are plotted in the vertical direction, the time scale is set in the horizontal direction, and the respective phases of supplementary charging, constant current charging and constant voltage charging are arranged in time series as in the case of FIG. 7.

In the second embodiment, it has been described in detail that the current value is changed from I2 to I3 at the time when the constant current charging is shifted to the constant voltage charging (see Point A of FIG. 11; A is circled). However, in the case that the impedance loss Vp is generated, it is difficult to detect the true voltage V (V6 in the figure) of the battery cell 21, and the voltage Vp+V, that is, the sum of the impedance loss Vp and the true voltage V, is eventually detected. “The true voltage V of the battery cell 21” herein means that the portion controlling the essential battery function is the portion of the battery cell 21 and that the voltage at this portion corresponds to the true voltage to be monitored essentially.

More specifically, in the case that the voltage of the secondary battery 20 is monitored on the side of the charger 30 as in the second embodiment, it is difficult to detect the true voltage V6 (for example, 3.85 V) of the battery cell 21 due to the internal impedance R of the protection circuit 22 and other circuits. In the case that this is explained by using specific numerical examples, when it is assumed that R=100 mΩ and I2=4.0 A, an impedance loss of 100 mΩ×4.0 A=0.4 V (R×I2=Vp) is calculated, whereby 0.4 V+3.85 V=4.25 V (Vp+V) is detected. In other words, 4.25 V is detected at the voltage detection section 52; as a result, the constant current charging is completed early and the constant voltage charging is started (see Point B of FIG. 11), and this may extend the charging time.

The third embodiment provides an example in which the loss during charging is reduced and the effect of the quick charging is enhanced by correcting the voltage at which the constant voltage charging is started depending on the predetermined impedance R0 and the value of the charging current.

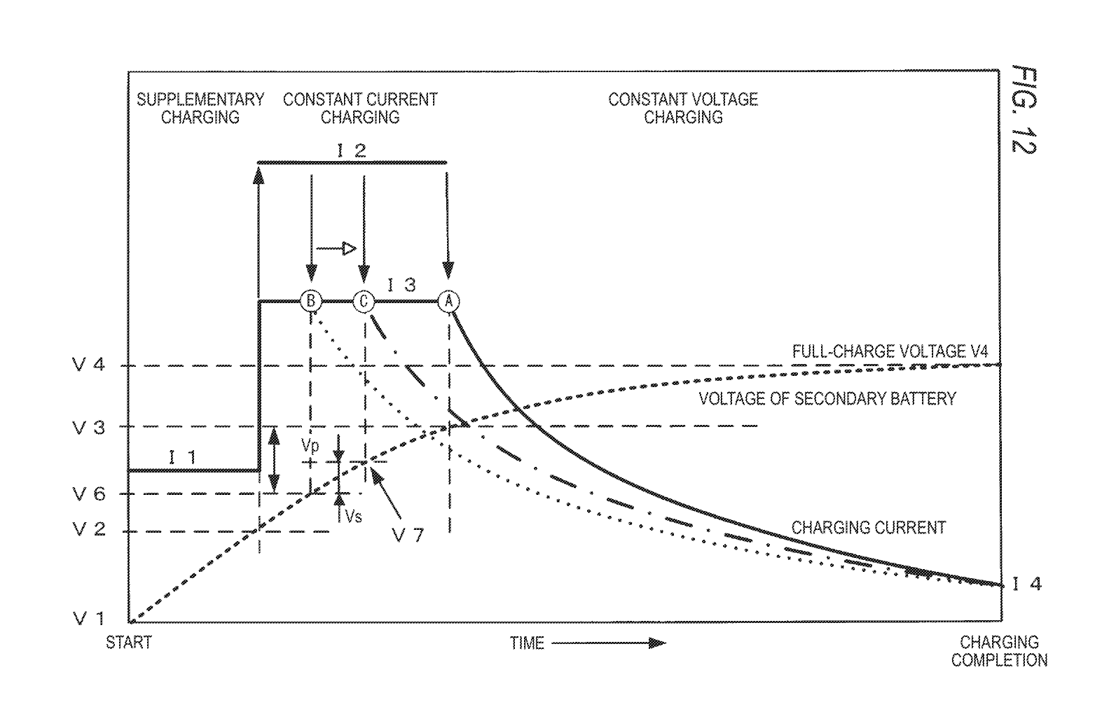

FIG. 12 is a graphic conceptual view showing an example of the charged state after voltage correction was performed.

For the impedance loss Vp based on the internal impedance R, impedance correction is performed using the predetermined impedance R0 that is based on a design value and is equal to or less than the internal impedance R, and the offset voltage Vs is determined. The offset voltage Vs is defined by the product of the predetermined impedance R0 and the current value I flowing in the secondary battery 20. In other words, R0×I=Vs is obtained. The predetermined impedance R0 is determined by the charger side authentication section 33 that receives a notice coming from the electronic device 1 that acquires the internal impedance R, for example, via the Internet, and at the same time the charger side authentication section 33 calculates the offset voltage Vs. Furthermore, it is possible that the predetermined impedance R0 and the offset voltage Vs are determined and calculated by the battery authentication section 12 and the terminal side authentication section 13 of the electronic device 1 and then notified to the charger side authentication section 33.

Next, voltage correction will be described using specific numerical examples. In FIG. 12, it is assumed that the current I2 flowing in the secondary battery 20 is 4 A, and the predetermined impedance R0 is 50 mΩ.

The offset voltage Vs is 50 mΩ×4 A, that is, 0.2 V. The voltage V7 of the battery cell is 4.05 V at the time when it is judged that the voltage has reached the constant voltage charging start voltage V3 (4.25 V). In other words, V3=V7+Vs is satisfied, whereby V7=V3−Vs is obtained; when specific numerical examples are used, 4.05 V=4.25 V−0.2 V is obtained. The start of the constant voltage charging is moved to Point C of FIG. 12 and the effect of the charging is improved by performing the voltage correction. In addition, overcharging can be avoided by making the predetermined impedance R0 smaller than the internal impedance R.

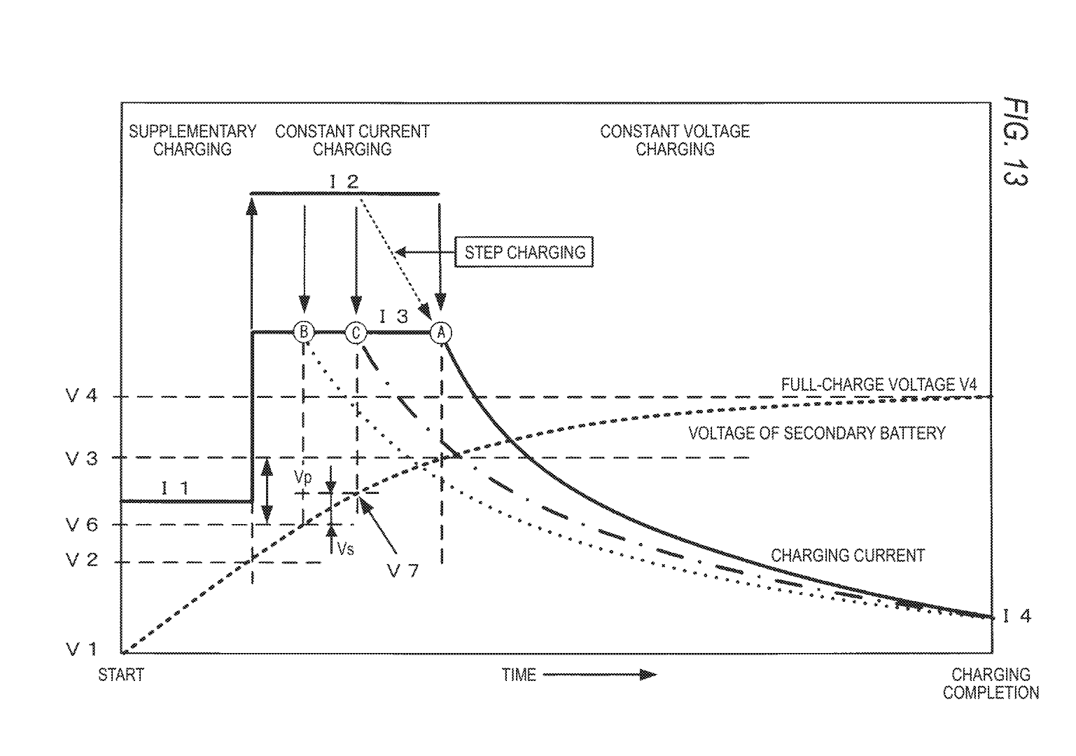

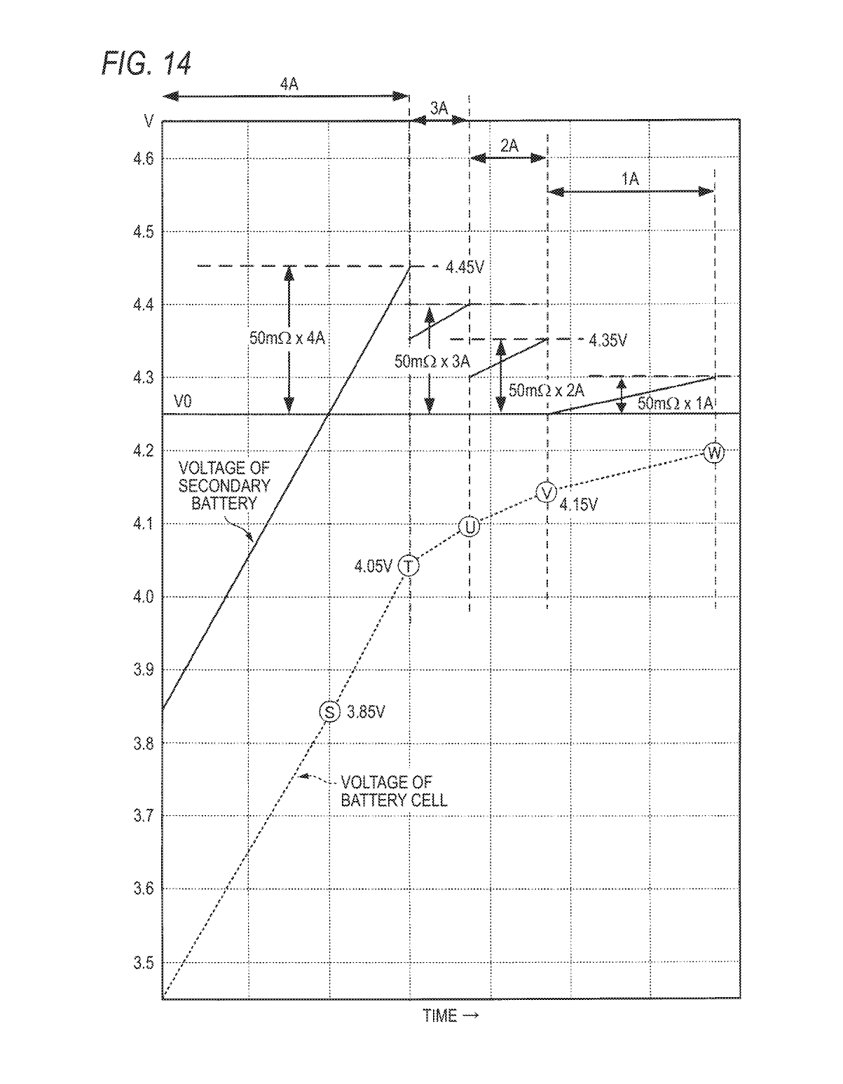

FIGS. 13 and 14 show step charging, FIG. 13 is a graphic conceptual view showing the positions at which the step charging is performed, the positions being specifically indicated using broken line arrows (actually, a stepwise shape having steps represented by 4 A, 3 A, 2 A and 1 A in FIG. 14), and FIG. 14 is a graphic conceptual view showing specific numerical examples in the step charging.

The step charging is charging in which the current I2 during the constant current charging described in the second embodiment is not lowered abruptly to the current I3 used at the start time of the constant voltage charging but is lowered gradually. For example, 4 A is lowered stepwise to 3 A and to 2 A and then eventually to 1 A, and the constant current charging is performed; however, the number of the steps is not limited to four, but may be larger or smaller, or a gradual change in which the current value is changed little by little may also be used. The charging time is shortened and the charging current is decreased sequentially by performing the step charging, whereby the accuracy of the voltage correction can be improved.

The step charging will be described using the specific numerical examples shown in FIG. 14. In FIG. 14, the voltage value is plotted in the vertical direction, and the charging time is plotted in the horizontal direction. The voltage of the secondary battery 20 is indicated by a solid-line bar graph, the voltage of the battery cell 21 is indicated by a broken-line bar graph, and the charging current is indicated by a bi-directional arrow. Furthermore, the predetermined voltage value V0 which is determined beforehand and at which the constant voltage charging starts is set to 4.25 V as a specific numerical example.

<First Step Charging>

When the constant current charging is started at the current value 4 A, the voltage of the battery cell 21 rises, and the voltage of the secondary battery 20 also rises. When the voltage of the secondary battery 20 reaches 4.25 V, the phase is shifted to the phase of constant voltage charging in the second embodiment, and the voltage of the battery cell 21 becomes 3.85 V, lower than 4.25 V (see Point S). In the third embodiment, however, the impedance correction is performed, and the offset voltage is set to 0.2 V (0.2 V=50 mΩ×4 A). Then, the charging at 4 A is performed until the voltage reaches 4.45 V (=4.25 V+0.2 V), that is, the value obtained by adding the offset voltage Vs. Hence, the voltage of the battery cell 21 can be raised up to 4.05 V (see Point T). The above-mentioned 4.45 V is obtained by the predetermined voltage value V0+the offset voltage Vs and is described below as a threshold voltage Vt.

<Second Step Charging>

Next, the charging current is lowered to 3 A, and the threshold voltage Vt is set to 4.4 V (=4.25 V+0.15 V; 0.15 V=50 mΩ×3 A). The voltage of the battery cell 21 can be raised up to 4.1 V by performing the charging at 3 A until the threshold voltage reaches 4.4 V (see Point U).

<Third Step Charging>

Furthermore, the charging current is lowered to 2 A, and the threshold voltage Vt is set to 4.35 V (=4.25 V+0.1 V; 0.1 V=50 mΩ×2 A). The voltage of the battery cell 21 can be raised up to 4.15 V by performing the charging at 2 A until the threshold voltage reaches 4.35V (see Point V).

<Fourth Step Charging>

Then, the current value is lowered to 1 A, and the threshold voltage Vt is set to 4.3 V (=4.25 V+0.05 V; 0.05 V=50 mΩ×1 A). The voltage of the battery cell 21 can be raised up to 4.2 V by performing the charging at 1 A until the threshold voltage reaches 4.3 V (see Point W). Although the current value is lowered to 1 A, the charging is not immediately shifted to the constant voltage charging, but the step charging continues until the voltage reaches the threshold voltage 4.3 V that is obtained by the voltage correction.

The difference between the voltage of the battery cell 21 and the voltage of the secondary battery 20 is gradually decreased by performing the step charging during the constant current charging. In addition, the efficiency of the quick charging is improved, whereby the charging time can be shortened. Furthermore, although the current value 1 A is the current at the start time of the constant voltage charging, since the constant current charging is performed until the voltage reaches the threshold voltage Vt, the influence of the internal impedance R is further reduced, whereby the voltage of the battery cell 21 can be made close to the predetermined voltage value V0. The above-mentioned numerical values are merely examples and the values of the present invention are not particularly limited to these values.

Since the voltage V of the secondary battery 20, the offset voltage Vs and the current value I described above change, the voltage values are represented, for example, by V1, V2, V3, . . . and the current values are represented, for example, by I1, I2, I3, . . . ; however, the values are not particularly limited to be represented as described above, but may be represented by generalized variables. For example, the offset voltage may be represented by Vn and the current value may be represented by In. However, n is a positive integer of 1 or larger (n=1, 2, 3, . . . ), and a value with a smaller variable is larger than a value with a larger variable; when current values are taken as examples, a relationship of 1ₙ>Iₙ₊₁ is established. In the case that values are represented using variables, the threshold voltage Vt which is the sum of the predetermined voltage value V0 and the offset voltage Vₙ is the nth value; when the threshold voltage reaches the nth threshold voltage Vn, the current value is expressed such that the current value Iₙ changes to the current value Iₙ₊₁. Furthermore, it may be explained that the offset voltage Vₙ is a first offset voltage and that an offset voltage Vₙ₊₁ smaller than the offset voltage Vₙ is a second offset voltage, and it may also be explained that the current value Iₙ is a first current value and that the current value Iₙ₊₁ smaller than the current value Iₙ is a second current value.

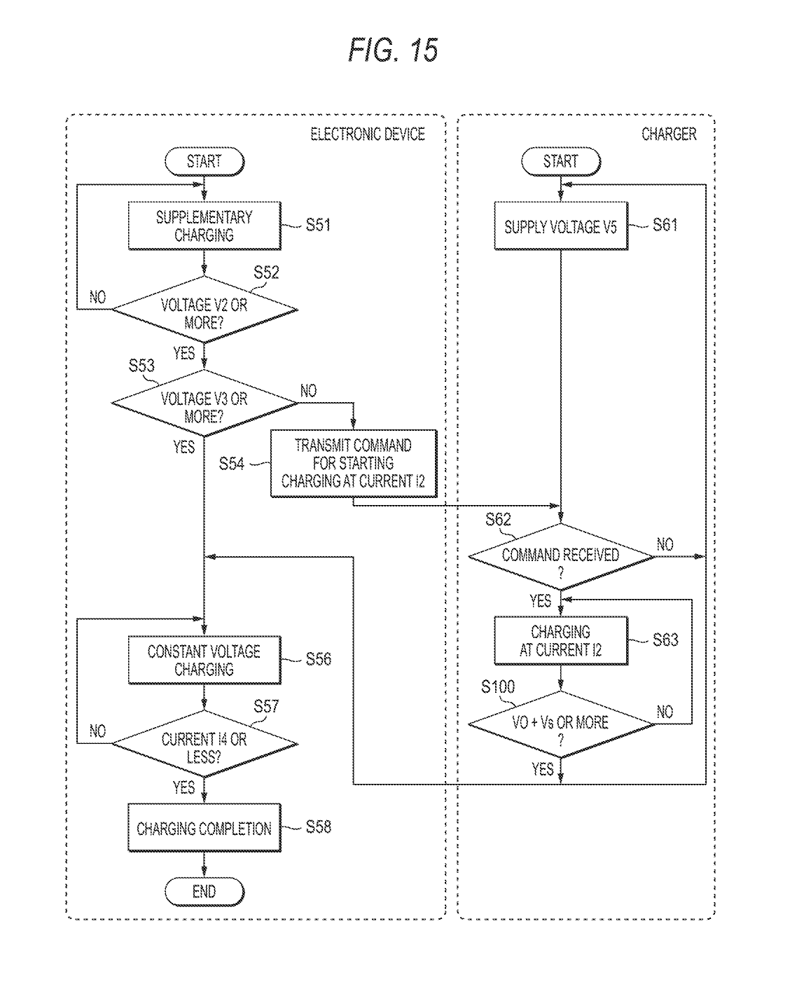

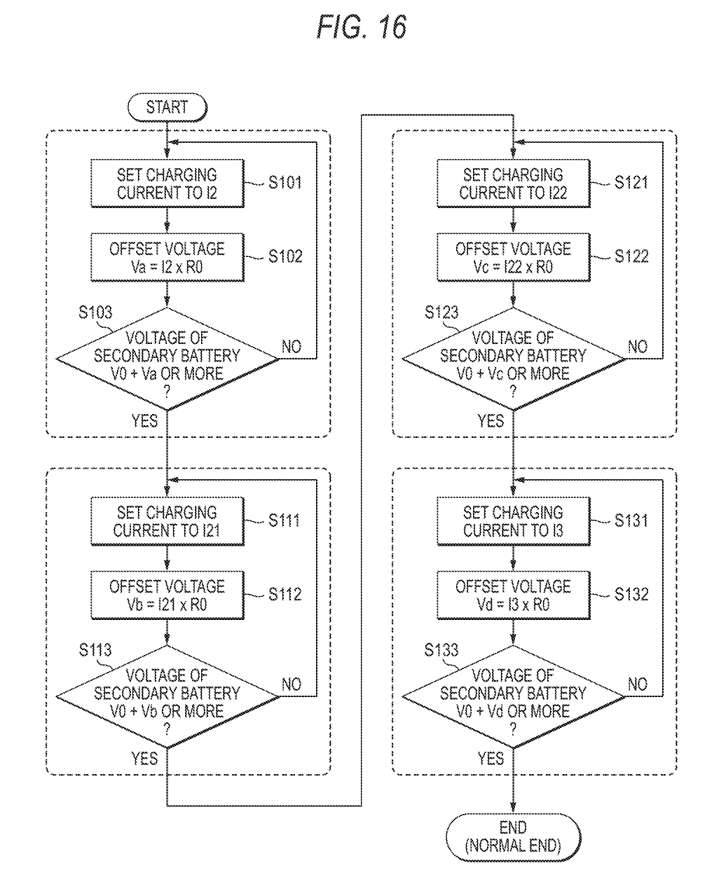

FIG. 15 is a flow chart obtained by partially modifying the flow chart explained referring to FIG. 6 according to the second embodiment so as to correspond to the third embodiment. The same steps as those of the second embodiment are designated by the same reference numerals, and their descriptions are omitted. The modification is the addition of the judgment (at step S100) of the threshold voltage Vt (=the predetermined voltage V0+the offset voltage Vs) in which the judgment of the step charging is made after the constant current charging was started by the constant current control at step S63. Then, when the step charging is completed (Yes at step S100), the constant voltage charging at step S56 is performed. Step S100 will be described in detail using FIG. 16.

FIG. 16 is a flow chart showing an example of a flow in the step charging. The current values of the charging currents at the respective steps of the step charging are represented by I2, I21, I22 and I3 (I2>I21>I22>I3), and the offset voltages Vs at the respective current values are represented by Va, Vb, Vc and Vd (Va>Vb>Vc>Vd).

<First Step Charging>

When the constant current charging is started, the current value I2 (for example, 4 A) is passed from the side of the charger 30 to the electronic device 1, and the quick charging is started at the charging current I2 (at step S101). The charger side authentication section 33 determines the predetermined impedance R0 on the basis of the internal impedance R obtained by the battery authentication section 12 and calculates an offset voltage Va (=I2×R0) (at step S102) and then notifies the charger side switching judgment section 62. The charger side switching judgment section 62 judges whether the voltage V of the secondary battery 20 acquired from the voltage detection section 52 is equal to or more than the threshold voltage Vt (for example, 4.45 V) that is the sum of the predetermined voltage value V0 (for example, 4.25 V) and an offset voltage Va (for example, 0.2 V) (at step S103). In other words, a judgment is made as to whether the relationship of Vt≧0+Va is established. In the case that the voltage has not reached the threshold voltage Vt (No at step S103; Vt<V0+Va), the charging at the current value I2 continues. In the case that the voltage is equal to or more than the threshold voltage Vt (Yes at step S103; Vt≧0+Va), the charging shifts to the constant current charging at the current value I21 (for example, 3 A) smaller than the current value I2 (at step S111).

<Second Step Charging>

The current value I21 (for example, 3 A) is passed from the side of the charger 30 to the electronic device 1, and the constant current charging at the current value I21 is performed (at step S111). The charger side authentication section 33 calculates an offset voltage Vb (=I21×R0) (at step S112). The charger side authentication section 33 calculates the offset voltage Vb by grasping the constant current flowing from the charger 30 to the electronic device 1. The value of the flowing constant current (I21 in the second step charging) can be received from the overcurrent detection section 15 via the terminal control circuit 11 or can be received from the charger side charge control section 65. The charger side switching judgment section 62 judges whether the voltage of the secondary battery 20 is equal to or more than the threshold voltage Vt (for example, 4.4 V) that is the sum of the predetermined voltage value V0 and the offset voltage Vb (for example, 0.15 V) (at step S113). In the case that the voltage has not reached the threshold voltage Vt (No at step S113), the charging continues at the current value I21; in the case that the voltage is equal to or more than the threshold voltage Vt (Yes at step S113), the charging shifts to the constant current charging at the current value I22 (for example, 2 A) smaller than the current value I21 (at step S121).

<Third Step Charging>

The current value I22 (for example, 2 A) is passed from the side of the charger 30 to the electronic device 1, and the constant current charging at the current value I22 is performed (at step S121). The charger side authentication section 33 calculates an offset voltage Vc (=I22×R0) (at step S122). The charger side switching judgment section 62 judges whether the voltage of the secondary battery 20 is equal to or more than the threshold voltage Vt (for example, 4.35 V) that is the sum of the predetermined voltage value V0 and the offset voltage Vc (for example, 0.1 V) (at step S123). In the case that the voltage has not reached the threshold voltage Vt (No at step S123), the charging continues at the current value I22; in the case that the voltage is equal to or more than the threshold voltage Vt (Yes at step S123), the charging shifts to the constant current charging at the current value I3 (for example, 1 A) smaller than the current value I22 (at step S131).

<Fourth Step Charging>

The current value I3 (for example, 1 A) is passed from the side of the charger 30 to the electronic device 1, and the constant current charging at the current value I3 is performed (at step S131). The charger side authentication section 33 calculates an offset voltage Vd (=I3×R0) (at step S132). The charger side switching judgment section 62 judges whether the voltage of the secondary battery 20 is equal to or more than the threshold voltage Vt (for example, 4.3 V) that is the sum of the predetermined voltage value V0 and the offset voltage Vd (for example, 0.05 V) (at step S133). In the case that the voltage has not reached the threshold voltage Vt (No at step S133), the charging continues at the current value I3; in the case that the voltage is equal to or more than the threshold voltage Vt (Yes at step S133), the step charging ends normally.

The range from step S101 to step S103 corresponds to the first step charging in which the charging is performed at the current I2 and the step charging is enclosed by a broken-line frame In FIG. 16. Similarly, each of the step charging is enclosed by a broken-line frame; in the case that the charging current value is set more finely or the number of the charging current values to be set is increased, the number of the broken-line frames in the flow chart increases. The first, the second, . . . are merely terms used for convenience of explanation and the use of the terms is not limited particularly.

The present invention is not limited to the above-mentioned embodiments but can be modified, improved, etc. appropriately. In addition, the materials, shapes, dimensions, numerical values, types, quantities, disposition places, etc. of the respective components in the above-mentioned embodiments are arbitrary and not limited, provided that the present invention can be attained.

The present application is based on Japanese Patent Application JP-2012-279515 filed on Dec. 21, 2012, Japanese Patent Application JP-2013-008540 filed on Jan. 21, 2013, and Japanese Patent Application JP-2013-023454 filed on Feb. 8, 2013, and the contents of which are herein incorporated by reference.

### INDUSTRIAL APPLICABILITY

The electronic device, the charger and the electronic device system according to the present invention are applicable to uses in which the secondary batteries of mobile phones, such as smart phones; mobile terminals, such as tablets; digital cameras; portable personal computers; wireless apparatuses; etc. are charged safely.

### DESCRIPTION OF REFERENCE NUMERALS AND SIGNS

1: electronic device
10: terminal section
11: terminal control circuit
12: battery authentication section
13: terminal side authentication section
14: voltage range detection section
15: overcurrent detection section
16: switch section
20: secondary battery
21: battery cell
22: protection circuit
23: storage section
30: charger
31: charge control circuit
32: output section
33: charger side authentication section
51: terminal side charge control section
52: voltage detection section
53: terminal side switching judgment section
62: charger side switching judgment section
63: exclusive switching circuit
64: power supply circuit
P1: charging connection section
P2: charging connection section of charger
T1: authentication communication connection section
T2: authentication communication connection section of charger

1. An electronic device being operable by using a detachable secondary battery as a power source, the electronic device comprising:
first and second charging connection sections configured to be connected to an external charger;
a switch section configured to perform switching between conduction and shut-off of an electric path for electrically connecting the first charging connection section and the detachable secondary battery when the detachable secondary battery is mounted;
a communication connection section configured to at least receive first authentication data from and transmit second authentication data to the external charger; and
a charging power output section configured to output the charging power supplied from the second charging connection section to the secondary battery,
wherein the switch section can become conductive in the case that the first authentication data received by the electronic device is predetermined data and that the charging voltage applied to the first charging connection section after the electronic device transmits the second authentication data is within a predetermined range, and the switch section cannot become conductive at least in the case that the received first authentication data is not the predetermined data; and
wherein the secondary battery can be charged by using the charging power supplied to either the first charging connection section or the second charging connection section.

2. The electronic device according to claim 1, further comprising:
a second communication connection section configured to transmit at least command data to the external charger,
wherein charging power is supplied to either the first charging connection section or the second charging connection section on the basis of the transmitted command data.

3. An electronic device being operable by using a detachable secondary battery as a power source, the electronic device comprising:
first and second charging connection sections configured to be connected to an external charger;
a switch section electrically connected to the first charging connection section and the detachable secondary battery when the detachable secondary battery is mounted and configured to perform switching between conduction and shut-off;
a communication connection section configured to at least receive first authentication data from and transmit second authentication data to the external charger; and
a charging power output section configured to output the charging power supplied from the second charging connection section to the secondary battery at a predetermined level,
wherein the switch section can become conductive in the case that the first authentication data received by the electronic device is predetermined data and that the charging voltage applied to the first charging connection section after the electronic device transmits the second authentication data is almost the same as a predetermined value, and the switch section cannot become conductive at least in the case that the received first authentication data is not the predetermined data or the applied charging voltage is not almost the same as the predetermined value; and
wherein the secondary battery can be charged by using the charging power supplied to either the first charging connection section or the second charging connection section.

4. The electronic device according to claim 3, further comprising:
a second communication connection section configured to transmit at least command data to the external charger,
wherein charging power is supplied to either the first charging connection section or the second charging connection section on the basis of the transmitted command data.

5. An electronic device system comprising:
an electronic device, being operable by using a secondary battery as a detachable power source, comprising: a first charging connection sections configured to be connected to an external charger; a switch section electrically connected to the first charging connection section and the detachable secondary battery when the detachable secondary battery is mounted and configured to perform switching between conduction and shut-off; a first communication connection section configured to at least receive first authentication data from and transmit second authentication data to the external charger; and a second communication connection section configured to transmit at least command data; and
a charger comprising: a second charging connection section configured to be connected to the electronic device; a third communication connection section configured to at least transmit the first authentication data to and receive the second authentication data from the electronic device; a fourth communication connection section configured to at least receive the command data from the electronic device; and a first charging power output section configured to output charging power to the second charging connection section,
wherein the switch section can become conductive in the case that the first authentication data received by the electronic device is predetermined data and that the charging voltage applied to the first charging connection section after the electronic device transmits the second authentication data is almost the same as a predetermined value, and the switch section cannot become conductive at least in the case that the received first authentication data is not the predetermined data or the applied charging voltage is not almost the same as the predetermined value; and
wherein the charger performs control for judging whether the first charging power output section outputs a predetermined current to the second charging connection section on the received command data.

6. The electronic device system according to claim 5, wherein the first charging connection section and the first communication connection section of the electronic device are used in common, and the second charging connection section and the third communication connection section of the charger are used in common.

7. The electronic device system according to claim 5, wherein the charger comprises a third charging connection section configured to be connected to the electronic device,
wherein the electronic device comprises a fourth charging connection section configured to be connected to the external charger and a second charging power output section configured to output the charging power supplied from the fourth charging connection section to the secondary battery at a predetermined level; and
wherein the second charging power output section can output charging power to the secondary battery at least in the case that the first charging power output section does not output the predetermined current to the second charging connection section.
